(19) United States
(12) Patent Application Publication
(10) Pub. No.: US 2013/0047931 A1
(43) Pub. Date: Feb. 28, 2013

(54) PET CHEW BALL

(71) Applicant: Chih-Cheng LAI, Taipei (TW)

(72) Inventor: Chih-Cheng LAI, Taipei (TW)

(21) Appl. No.: 13/214,727

(22) Filed: Aug. 22, 2011

(51) Int. Cl. A01K 29/00

(52) U.S. Cl. 119/710

(57) ABSTRACT

A pet chew ball has a body and a snack rope. The body is spherical and has a through hole formed through the body. The snack rope is composed of at least one strand, is longer than the through hole in length, is replaceably mounted through the through hole of the body and has a bight. Two knots are tied in the bight of the snack rope to respectively abut against and block the open ends of the through hole so that the snack rope can be securely combined with the body. Since the additional flavor of the snack rope can whet the desire of pets in biting and chewing the pet chew ball and the snack rope can always be replaced, the pet chew ball prolongs pets' chewing pleasure toward the pet chew ball for sake of the constant availability of the snack rope.

### BACKGROUND OF THE INVENTION

1. Field of the Invention

The present invention relates to a pet chew ball, and more particularly to a pet chew ball having a snack rope securely mounted through a through hole of the pet chew ball.

2. Description of the Related Art

Chasing ball is probably one of the most frequent activities of pets. Partly like a toy and partly like a prey, balls can be chased after, played with and bitten by pets. Regular balls are usually made of inedible materials such as rubber, plastic and the like. When pets bite or chew the balls, certain ingredients of the inedible materials may jeopardize pets' health. To aim to be chewable at no risk of pets' health, conventional pet chew balls made of rawhide, cornstarch and other edible materials were brought into play.

Although the pet chew balls are edible, pets easily get bored with the monotonous taste of the pet chew balls and soon lose their interest in further biting and chewing the pet chew balls.

### SUMMARY OF THE INVENTION

An objective of the present invention is to provide a pet chew ball having a snack rope securely mounted through a through hole of the pet chew ball.

To achieve the foregoing objective, the pet chew ball has a body and a snack rope.

The body is spherical and has a through hole formed through the body and having two open ends.

The snack rope is composed of at least one strand, is longer than the through hole in length, is replaceably mounted through the through hole of the body and has two ends and a bight.

Two knots are tied in the bight of the snack rope to respectively abut against and block the open ends of the through hole.

As the snack rope can be securely combined with the body and the snack rope can always be replaced, the pet chew ball prolongs pets' chewing pleasure toward the pet chew ball for sake of the constant availability of the snack rope.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pet chew ball in accordance with the present invention;

FIG. 2 is an exploded perspective view of the pet chew ball in FIG. 1; and

FIG. 3 is an operational perspective view of the pet chew ball in FIG. 1.

### DETAILED DESCRIPTION OF THE INVENTION

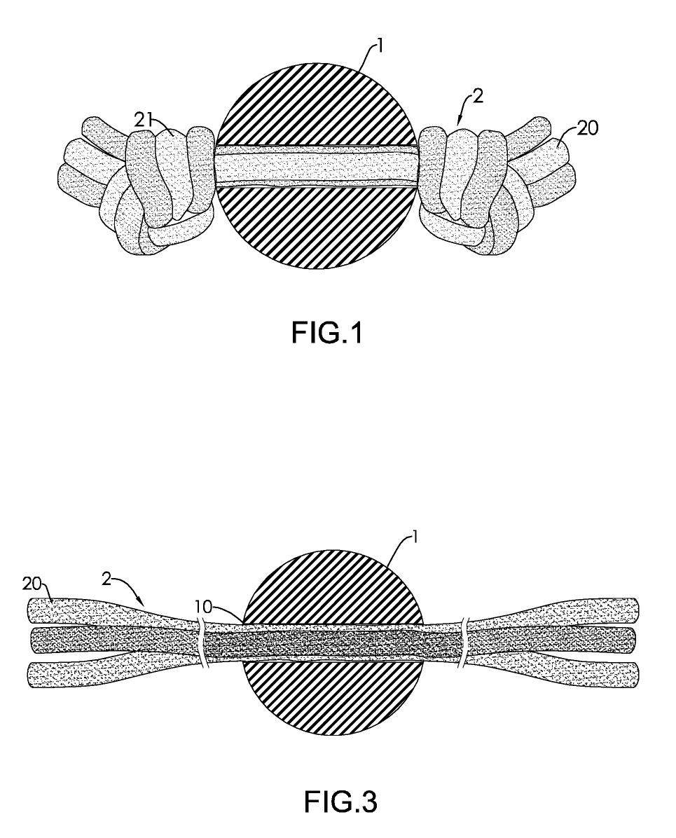

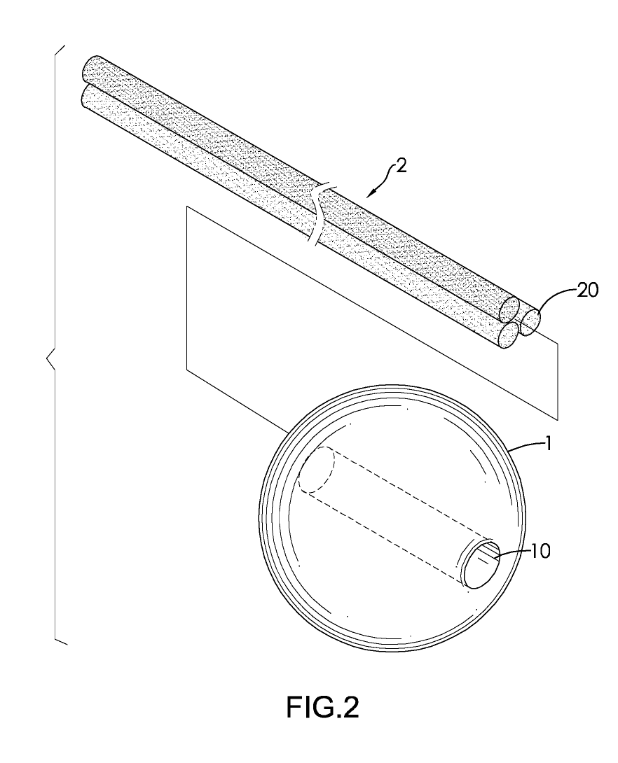

With reference to FIGS. 1 and 2, a pet chew ball in accordance with the present invention has a body 1 and a snack rope 2.

The body 1 is spherical and has a through hole 10. The through hole 10 is formed through the body 1 and has two open ends. The body 1 may be made of cornstarch.

The snack rope 2 is composed of at least one strand 20, is longer than the through hole 10 in length, and is replaceably mounted through the through hole 10 of the body 1. In the present embodiment, the snack rope 2 is composed of three strands 20 tightly gathered together. The snack rope 2 has two ends and a bight. Two knots 21 are tied in the bight of the snack rope 2 to respectively abut against and block the open ends of the through hole 10 of the body 1. Each one of the at least one strand 20 of the snack rope 10 may be made of rawhide or meat product such as meat strip, and may be added with flavorings so that the strand can taste like chicken, bacon and the like.

With reference to FIGS. 1 and 3, the snack rope 2 is mounted through the through hole 10 of the body 1 with both ends of the snack rope 2 respectively exposed beyond the two open ends of the through hole 10. The three strands 20 of the snack rope 2 are tightly juxtaposed and align with one another. An overhand knot 21 is tied in the bight of the snack rope to abut against one of the open ends of the through hole 10 and another overhand knot 21 is tied in the bight of the snack rope 2 to abut against the other open end of the through hole 10. The area of a cross section of each overhand knot 21 is larger than the area of the corresponding open end of the through hole 10 so that the overhand knot 21 can block the opening without slipping into the through hole 10. When the snack rope 2 is finished off by pets or comes off, a new snack rope can be replaced by repeating the foregoing procedures. Since the overhand knot 21 is the simplest knot to tie, users can manually tie the two knots 21 by themselves. When the two overhand knots 21 are tied to respectively abut against the two open ends of the through hole 10, the replacement of the snack rope 2 is completed as shown in FIG. 1.

The pet chew ball of the present invention has the snack rope 2 adding additional flavor to the conventional pet chew ball to whet pets' desire for biting and chewing the pet chew ball. As the snack rope 2 is securely mounted through the body 1 of the pet chew ball by tying two knots 21 in the bight of the snack rope 2 to abut against the two open ends of the through hole 10, the snack rope 2 is not easy to come off. Additionally, once the snack rope 2 is finished off or bitten off by pets, the snack rope 2 can still be replaced easily. Accordingly, the pet chew ball of the present invention prolongs pets' chewing pleasure toward the pet chew ball for sake of the constant availability of the snack rope 2.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A pet chew ball comprising:
a body being spherical and having a through hole formed through the body and having two open ends; and
a snack rope composed of at least one strand, longer than the through hole in length, replaceably mounted through the through hole of the body and having two ends and a bight;
wherein two knots are tied in the bight of the snack rope to respectively abut against and block the open ends of the through hole.

2. The pet chew ball as claimed in claim 1, wherein the body is made of cornstarch.

3. The pet chew ball as claimed in claim 1, wherein each one of the at least one strand of the snack rope is made of rawhide.

4. The pet chew ball as claimed in claim 2, wherein each one of the at least one strand of the snack rope is made of rawhide.

5. The pet chew ball as claimed in claim 1, wherein each one of the at least one strand of the snack rope is added with flavorings to have a chicken flavor or a bacon flavor.

6. The pet chew ball as claimed in claim 2, wherein each one of the at least one strand of the snack rope is added with flavorings to have a chicken flavor or a bacon flavor.

7. The pet chew ball as claimed in claim 3, wherein each one of the at least one strand of the snack rope is added with flavorings to have a chicken flavor or a bacon flavor.

8. The pet chew ball as claimed in claim 1, wherein each one of the at least one strand of the snack rope is added with flavorings to have a chicken flavor or a bacon flavor.

9. The pet chew ball as claimed in claim 1, wherein each knot tied in the bight of the snack rope is an overhand knot.

10. The pet chew ball as claimed in claim 2, wherein each knot tied in the bight of the snack rope is an overhand knot.

11. The pet chew ball as claimed in claim 3, wherein each knot tied in the bight of the snack rope is an overhand knot.

12. The pet chew ball as claimed in claim 4, wherein each knot tied in the bight of the snack rope is an overhand knot.

13. The pet chew ball as claimed in claim 5, wherein each knot tied in the bight of the snack rope is an overhand knot.

14. The pet chew ball as claimed in claim 6, wherein each knot tied in the bight of the snack rope is an overhand knot.

15. The pet chew ball as claimed in claim 7, wherein each knot tied in the bight of the snack rope is an overhand knot.

16. The pet chew ball as claimed in claim 8, wherein each knot tied in the bight of the snack rope is an overhand knot.
